(19) United States
(12) Patent Application Publication
(10) Pub. No.: US 2025/0391887 A1
(43) Pub. Date: Dec. 25, 2025

(54) ELECTRODE CURRENT COLLECTOR AND METHOD OF MANUFACTURING THE SAME

(71) Applicant: Korea Institute of Science and Technology, Seoul (KR)

(72) Inventors: Jong Ho LEE, Seoul (KR); Kyung Joong Yoon, Seoul (KR); Sun-Young Park, Seoul (KR); Ji-Won Son, Seoul (KR); Hyoungchul Kim, Seoul (KR); Sungeun Yang, Seoul (KR); Ho-il JI, Seoul (KR); Deok-Hwang Kwon, Seoul (KR); Jong hoon Joo, Seoul (KR); Hye Song An, Seoul (KR); Gyeong Duk Nam, Seoul (KR)

(21) Appl. No.: 18/811,599

(22) Filed: Aug. 21, 2024

(30) Foreign Application Priority Data
Jun. 25, 2024 (KR) 10-2024-0082888

(51) Int. Cl. H01M 8/0232; H01M 8/0243; H01M 8/0637

(52) U.S. Cl. CPC H01M 8/0232; H01M 8/0243; H01M 8/0637

(57) ABSTRACT

An electrode current collector includes an alloy containing Ni and Cu, and CeO2, wherein a porosity of the electrode current collector is 25 to 80%. A method of manufacturing an electrode current collector includes preparing a mixed powder by mixing an alloy powder containing Ni and Cu with CeO2, manufacturing a molded body by applying a pressure to the mixed powder, and subjecting the molded body to a heat treatment at 450 to 1,000° C.

### CROSS-REFERENCE TO RELATED APPLICATION

This application claims priority to and the benefit of Korean Patent Application No. 10-2024-0082888 filed in the Korean Intellectual Property Office on Jun. 25, 2024, the entire contents of which are incorporated herein by reference.

### BACKGROUND OF THE INVENTION

### (a) Field of the Invention

An exemplary embodiment of the present disclosure relates to an electrode current collector and a method of manufacturing the same, and more particularly, to a current collector having a catalytic function applicable to a solid oxide fuel cell and a co-electrolysis cell, and a method of manufacturing the same.

### (b) Description of the Related Art

A solid oxide fuel cell (SOFC) and a high-temperature co-electrolysis cell (Co-SOEC) may directly utilize a hydrocarbon-based fuel due to their high-temperature operation characteristics, and have high energy conversion efficiency, and therefore, SOFC and Co-SOEC are attracting attention as future energy technologies for power and fuel production.

As an anode for SOFC or Co-SOEC, a general Ni metal catalyst, which is not a noble metal, and a zirconia-based solid electrolyte, which is an oxygen ion conductive ceramic, are most widely used in the form of a composite.

However, when a hydrocarbon-based fuel is used, a coking phenomenon in which carbon deposits on a surface of a Ni-based electrode may occur due to incomplete combustion of the fuel, and the carbon deposition may reduce an effective surface area required for an electrode reaction, resulting in deterioration of the performance and stability of the cell.

Therefore, when a hydrocarbon-based fuel is used, a pre-reforming device is installed outside, but using such a separate device causes additional costs due to facility construction and complexity in system configuration, which makes it difficult to secure the economic feasibility of the product.

Accordingly, a technology is recently under development to find a method of directly processing fuel inside a stack in which a cell is located without a separate reforming device.

As a method of directly processing fuel inside the stack, a method of infiltrating a noble metal catalyst such as ruthenium (Ru) or palladium (Pd) into an existing Ni-based anode has been proposed to achieve direct decomposition (reforming) of the fuel used inside the anode of the cell.

However, such a method requires a separate additional process in a cell manufacturing process, which not only increases process costs and worsens economic feasibility, but also makes it difficult to apply the method additionally to a cell process for which a commercialization process is already established.

Accordingly, there is a need for a novel current collector and manufacturing technology that may process fuel inside a stack while still utilizing an existing cell without changing a design of the stack.

### SUMMARY OF THE INVENTION

The present disclosure has been made in an effort to provide a current collector having advantages of processing fuel inside a stack while still utilizing an existing cell without changing a design of the stack, and a method of manufacturing the same. Specifically, the present disclosure has been made in an effort to provide a current collector having a catalytic function applicable to a solid oxide fuel cell and a co-electrolysis cell, and a method of manufacturing the same.

An exemplary embodiment of the present disclosure provides an electrode current collector including an alloy containing Ni and Cu, and CeO₂, wherein a porosity of the electrode current collector is 25 to 80%.

The alloy containing Ni and Cu may contain 20 to 50 parts by weight of Ni and 50 to 80 parts by weight of Cu, with respect to 100 parts by weight of the alloy.

CeO₂ may be included in an amount of 5 to 25 parts by volume with respect to 100 parts by volume of the alloy containing Ni and Cu.

Another exemplary embodiment of the present disclosure provides a method of manufacturing an electrode current collector, the method including: preparing a mixed powder by mixing an alloy powder containing Ni and Cu with CeO₂; manufacturing a molded body by applying a pressure to the mixed powder; and subjecting the molded body to a heat treatment at 450 to 1,000° C.

The alloy powder may contain 20 to 50 parts by weight of Ni and 50 to 80 parts by weight of Cu, with respect to 100 parts by weight of the alloy powder.

The mixed powder may include 100 parts by volume of the alloy powder and 5 to 25 parts by volume of CeO₂.

Yet another exemplary embodiment of the present disclosure provides a solid oxide fuel cell including the electrode current collector.

The electrode current collector according to an exemplary embodiment of the present disclosure may reduce the burden of directly processing fuel inside a solid oxide fuel cell or a co-electrolysis cell that uses a hydrocarbon-based fuel.

The electrode current collector according to an exemplary embodiment of the present disclosure may additionally serve as a catalyst to decompose a hydrocarbon-based fuel such as methane into hydrogen and carbon monoxide.

In the electrode current collector according to an exemplary embodiment of the present disclosure, CeO₂ and the like may also act as a promoter that may activate a catalytic reaction of an alloy material, which may improve the decomposition reaction of hydrocarbons.

### BRIEF DESCRIPTION OF THE DRAWINGS

FIG. 1 is a schematic view schematically illustrating a solid oxide fuel cell including an electrode current collector according to an exemplary embodiment of the present disclosure.

FIG. 2 is a schematic view illustrating a schematic mechanism for obtaining effects from an electrode current collector according to an exemplary embodiment of the present disclosure.

FIG. 3 is a photograph of an electrode current collector manufactured in Manufacture Example 1.

FIG. 4 is a graph of the results of X-ray diffraction analysis (XRD) measured in Experimental Example 1.

FIGS. 5, 6, 7, 8, 9, and 10 are scanning electron microscope (SEM) photographs obtained in Experimental Example 2.

FIGS. 11, 12, 13, and 14 are graphs showing methane reforming rates by temperature measured in Experimental Example 3.

FIG. 15 is a graph of electrical conductivity by temperature measured in Experimental Example 4.

FIGS. 16, 17, 18, 19, 20, and 21 illustrate the results of analyzing a current collector manufactured in Manufacture Example 2 with an SEM-EDS (energy dispersive X-ray spectroscope, EDS).

FIGS. 22, 23, and 24 are graphs showing methane reforming rates by temperature measured in Experimental Example 6.

### DETAILED DESCRIPTION OF THE EMBODIMENTS

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first part, component, region, layer, or section which will be described hereinafter may be referred to as a second part, component, region, layer, or section without departing from the scope of the present disclosure.

Terminologies used herein are to mention only a specific exemplary embodiment, and are not to limit the present disclosure. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

When any part is positioned “on” or “above” another part, it means that the part may be directly on or above the other part or another part may be interposed therebetween. In contrast, when any part is positioned “directly on” another part, it means that there is no part interposed therebetween.

Unless defined otherwise, all terms including technical terms and scientific terms used herein have the same meanings as understood by those skilled in the art to which the present disclosure pertains. Terms defined in a generally used dictionary are additionally interpreted as having the meanings matched to the related technical document and the currently disclosed contents, and are not interpreted as ideal or very formal meanings unless otherwise defined.

In the present specification, the term “combination(s) thereof” as described in Markush type expression means a mixture or combination of one or more selected from the group consisting of components described in Markush type expression, and means including one or more selected from the group consisting of the components.

Hereinafter, exemplary embodiments of the present disclosure will be described in detail so that those skilled in the art to which the present disclosure pertains may easily practice the present disclosure. However, the present disclosure may be implemented in various different forms and is not limited to exemplary embodiments described herein.

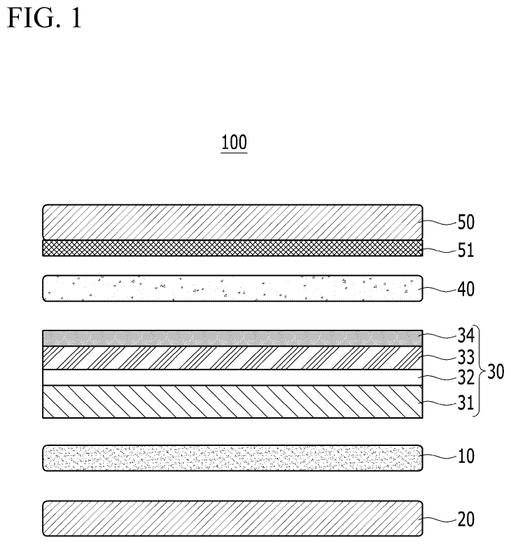

FIG. 1 schematically illustrates a solid oxide fuel cell 100 including an electrode current collector according to an exemplary embodiment of the present disclosure. Components other than the electrode current collector in the solid oxide fuel cell 100 of FIG. 1 are the same as those of a general solid oxide fuel cell 100. FIG. 1 illustrates an example of the solid oxide fuel cell 100, and it is possible to omit or add some components of the solid oxide fuel cell 100 illustrated in FIG. 1, if necessary.

As illustrated in FIG. 1, the solid oxide fuel cell 100 includes an anode bipolar plate 20, an anode current collector 10, a cell 30, a cathode current collector 40, and a cathode bipolar plate 50. In an exemplary embodiment of the present disclosure, the electrode current collector may be the anode current collector 10 or the cathode current collector 40, and more specifically, may be the anode current collector 10. For convenience, an example in which the electrode current collector is the anode current collector 10 will be described below.

Specifically, the cell 30 may include an anode 31, an anode functional layer 32, an electrolyte 33, and a cathode 34.

In addition, a bipolar plate coating layer 51 may be interposed between the cathode bipolar plate 50 and the cathode current collector 40.

As such, the solid oxide fuel cell 100 includes the current collectors 10 and 40 on both electrodes for electrical connection between the cell 30 and the metallic bipolar plates 20 and 50. The cell 30 formed of a ceramic material is a structure in which the porous anode 31 and cathode 41, where an electrochemical reaction occurs, are stacked on both sides with the dense electrolyte 33 in the center.

An exemplary embodiment of the present disclosure is characterized by the electrode current collector 10 having a catalytic function, and other components are the same as those of the general solid oxide fuel cell 100, and therefore, detailed descriptions will be omitted.

The electrode current collector 10 according to an exemplary embodiment of the present disclosure, which is obtained by imparting a catalytic function to an existing electrode current collector 10, which has been used only as an electron carrier to transmit a current generated in the cell 30 to the anode bipolar plate 20, has an additional function to advance the chemical reaction required for the anode 31.

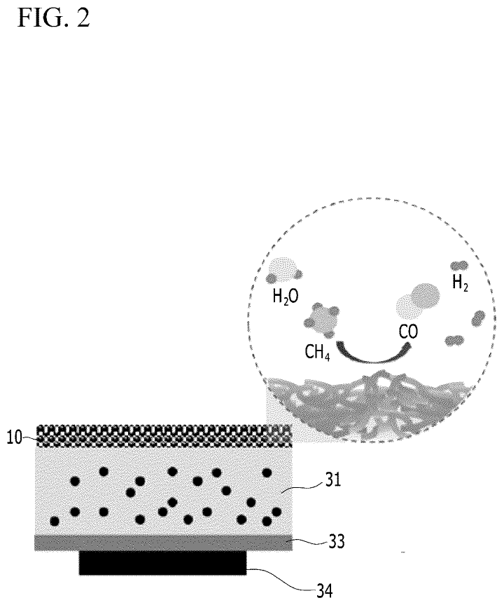

FIG. 2 schematically illustrates a mechanism of the electrode current collector 10 according to an exemplary embodiment of the present disclosure. As illustrated in FIG. 2, the electrode current collector 10 according to an exemplary embodiment of the present disclosure converts methane (CH₄) into carbon monoxide (CO) through catalysis.

To this end, the electrode current collector 10 according to an exemplary embodiment of the present disclosure may include an alloy containing Ni and Cu, and CeO₂, and may have a porosity of 25 to 80%.

The alloy containing Ni and Cu is selected because it has a high methane conversion and high H₂ and CO yields in the solid oxide fuel cell 100. It is possible to select other metals such as Fe instead of Ni and Cu, but in this case, the methane conversion and H₂ and CO yields may be significantly deteriorated.

The alloy containing Ni and Cu has a dense basic structure, and in this case, it is difficult to secure a porosity required for the catalytic reaction. By adding ceria (CeO₂), sintering of the alloy containing Ni and Cu may be suppressed, and the porosity required for the catalytic reaction may be secured. In addition, since ceria (CeO₂) itself has an ability to supply oxygen ions, ceria (CeO₂) may play a role in removing carbon as CO and CO₂ when carbon deposition occurs on a surface of the anode that occurs when hydrocarbons are used.

In an exemplary embodiment of the present disclosure, the porosity of the electrode current collector 10 is 25 to 80%. When the porosity is too low, it may be difficult to sufficiently obtain the desired catalytic reaction. When the porosity is too high, problems may occur in the strength of the electrode current collector 10. More specifically, the porosity of the electrode current collector 10 may be 50 to 75%. Still more specifically, the porosity of the electrode current collector 10 may be 60 to 68%. The porosity may be measured by the Archimedes density measurement method.

The Archimedes density measurement method is described in detail as follows. A magnitude of buoyancy acting on a weight of an object immersed in a fluid is equal to a weight of the fluid that occupies a submerged volume of the object. Therefore, the buoyancy may be regarded as the weight of the fluid displaced by the object, and may be calculated by multiplying a volume of the displaced fluid by a density of the fluid. Dry weight, underwater weight, and hydrated weight may be measured using an Archimedes density measurement kit.

The dry weight is a weight of a dry sample containing no moisture. The underwater weight is measured by a method by immersing the sample in water. The sample in water receives buoyancy equal to a volume of a portion of the sample, which is not immersed in water, and a close pore volume. Therefore, the weight of the sample in water is a value obtained by subtracting the buoyancy from the sample weight. The hydrated weight is a weight of the sample containing water, and water may only be contained in open pores. Therefore, the hydrated weight is the sample weight and the weight of water equivalent to an open pore volume.

Accordingly, in the Archimedes density measurement method, the porosity is calculated by dividing the dry weight by the value obtained by subtracting the underwater weight from the hydrated weight and the theoretical density of matter.

The porosity may be affected by conditions such as an addition ratio of CeO₂, and a pressure during molding and a temperature and time during a heat treatment in the manufacturing process.

The alloy containing Ni and Cu may contain 20 to 50 parts by weight of Ni and 50 to 80 parts by weight of Cu, with respect to 100 parts by weight of the alloy. In an exemplary embodiment of the present disclosure, part(s) by weight refer(s) to a relative weight ratio to the standard weight. When the amount of Ni contained is too small, it may be difficult to perform the basic role of the electrode current collector 10. When the amount of Cu contained is too small, excessive carbon deposition may occur. More specifically, the alloy may contain 25 to 35 parts by weight of Ni and 65 to 75 parts by weight of Cu.

CeO₂ may be included in an amount of 5 to 25 parts by volume with respect to 100 parts by volume of the alloy containing Ni and Cu. In an exemplary embodiment of the present disclosure, part(s) by volume refer(s) to a relative volume ratio to the standard volume. When the amount of CeO₂ included is too small, it is difficult to obtain sufficient pore formation and catalytic action due to addition of CeO₂. When the amount of CeO₂ included is too large, the strength of the electrode current collector 10 may be reduced. More specifically, CeO₂ may be included in an amount of 10 to 20 parts by volume with respect to 100 parts by volume of the alloy containing Ni and Cu. Still more specifically, CeO₂ may be included in an amount of 10 to 15 parts by volume.

In an exemplary embodiment of the present disclosure, the electrode current collector 10 has an excellent electrical conductivity. Specifically, the electrical conductivity of the electrode current collector 10 may be 1.0×10³ S/cm to 1.0×10⁴ S/cm at a temperature of 750° C.

According to an exemplary embodiment of the present disclosure, a method of manufacturing an electrode current collector 10 includes preparing a mixed powder by mixing an alloy powder containing Ni and Cu with CeO₂; manufacturing a molded body by applying a pressure to the mixed powder; and subjecting the molded body to a heat treatment.

Hereinafter, each step will be described in detail.

First, a mixed powder is prepared by mixing an alloy powder containing Ni and Cu with CeO₂. In this case, the alloy powder may contain 20 to 50 parts by weight of Ni and 50 to 80 parts by weight of Cu, with respect to 100 parts by weight of the alloy powder. In addition, the mixed powder may include 100 parts by volume of the alloy powder and 5 to 25 parts by volume of CeO₂. Since the ratios of Ni and Cu in the alloy powder and the ratios of the alloy powder and CeO₂ are the same as those of the electrode current collector 10 described above, overlapping descriptions will be omitted.

Next, a molded body is manufactured by applying a pressure to the mixed powder. In this case, the pressure applied to the mixed powder may be 318 kgf/cm² (31.19 MPa) to 637 kgf/cm² (62.49 MPa). When the pressure is too low, it is difficult to manufacture a molded body having an appropriate shape. When the pressure is too high, it is difficult to properly form pores in the electrode current collector 10. More specifically, the pressure applied to the mixed powder may be 414 kgf/cm² (40.60 MPa) to 541 kgf/cm² (53.05 MPa).

The molded body may be manufactured into various shapes by changing the required shape and size, and has a high degree of freedom in process. In addition, when technologies such as tape casting are applied, it may also be expanded to a large-area current collector mass production process used in commercial large-capacity stacks.

Next, the molded body is subjected to a heat treatment. At this time, a temperature may be 450 to 1,000° C. When the temperature is too low, the porosity may be lower than a target porosity due to heat shrinkage during an SOFC sealing process. When the temperature is too high, an appropriate porosity may not be obtained. More specifically, the temperature may be 800 to 1,000° C. The heat treatment process may include an oxidation heat treatment performed in an oxidizing atmosphere and a reduction heat treatment performed in a reducing atmosphere. Organic matter combusts in the oxidation heat treatment, and during this process, pores are formed, which may contribute to achieving a high porosity. A heat treatment time in the oxidation heat treatment may be 5 hours to 10 hours. A heat treatment time in the reduction heat treatment may vary depending on a temperature to be applied to SOFC (650° C. to 1,000° C.), and may be 3 hours to 15 hours.

Hereinafter, preferred examples and comparative examples of the present disclosure will be described. However, each of the following examples is merely a preferred example of the present disclosure, and the present disclosure is not limited to the following examples.

### <Manufacture Example: Manufacture of Electrode Current Collector>

First, the Pechini method was used to prepare a powder containing Ni and Cu. Copper(II) nitrate trihydrate (Cu(NO₃)₂·3H₂O), nickel nitrate hexahydrate (Ni(NO₃)₂·6H₂O), and cerium (III) nitrate hexahydrate (Ce(NO₃)·6H₂O) were dissolved in distilled water in a certain ratio. In order to facilitate synthesis, citric acid was added, the pH was adjusted to 7 using ammonium hydroxide, and then, synthesis was performed at about 80° C. until a gel form was formed. The gel was subjected to a heat treatment at about 200° C. for 1 hour to form char containing copper-nickel oxide, thereby preparing an alloy powder.

The char obtained through this was finely ground in a mortar, the powder was placed in a mold having a desired size and pressed by a press machine to form a plate shape, and then, an oxidation heat treatment (air gas) and a reduction heat treatment (H₂ gas) at 900° C. were performed.

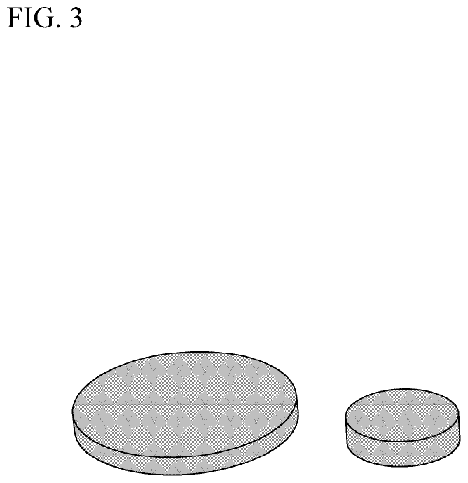

Electrode current collectors of Manufacture Example 1 (10 vol. % CeO₂—Cu_{0.7}Ni_{0.3}), Manufacture Example 2 (15 vol. % CeO₂—Cu_{0.7}Ni_{0.3}), and Manufacture Example 3 (20 vol. % CeO₂—Cu_{0.7}Ni_{0.3}) were manufactured by the above method. In addition, using the same method, an electrode current collector (Comparative Manufacture Example 1, Cu) was manufactured using a pure Cu powder, an electrode current collector (Comparative Manufacture Example 2, Ni) was manufactured using a pure Ni powder, and an electrode current collector (Comparative Manufacture Example 3, Cu_{0.7}Ni_{0.3}) was manufactured using an alloy powder of Ni and Cu without adding cerium (III) nitrate hexahydrate (Ce(NO₃)·6H₂O). FIG. 3 is a photograph of the electrode current collector manufactured in Manufacture Example 1.

### Experimental Example 1: XRD Analysis

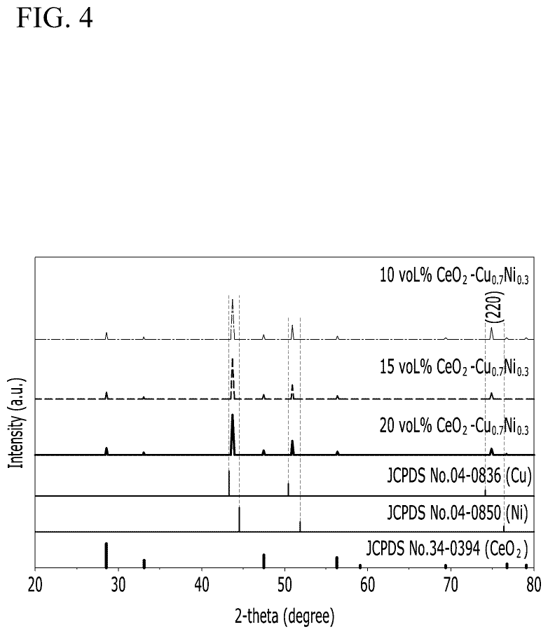

The electrode current collectors manufactured in the manufacture examples were subjected to X-ray diffraction analysis (XRD), and the results thereof were illustrated in FIG. 4.

As illustrated in FIG. 4, in all of Manufacture Examples 1 to 3, it was confirmed that a face centered cubic (FCC) structure was observed, and CeO₂ was present in the form of an oxide.

### Experimental Example 2: SEM Analysis

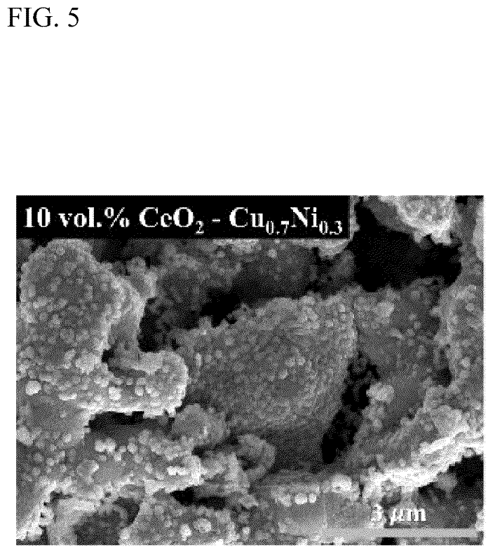

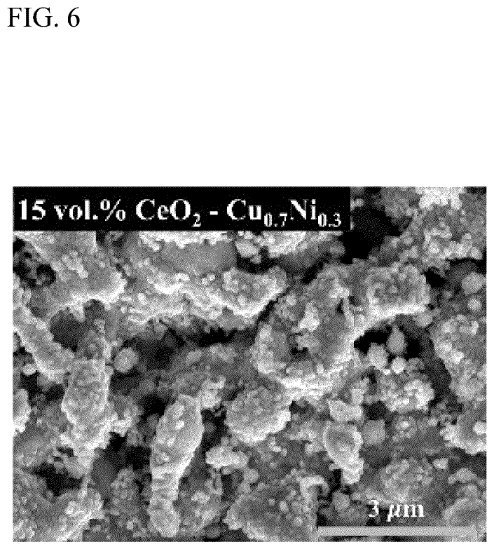

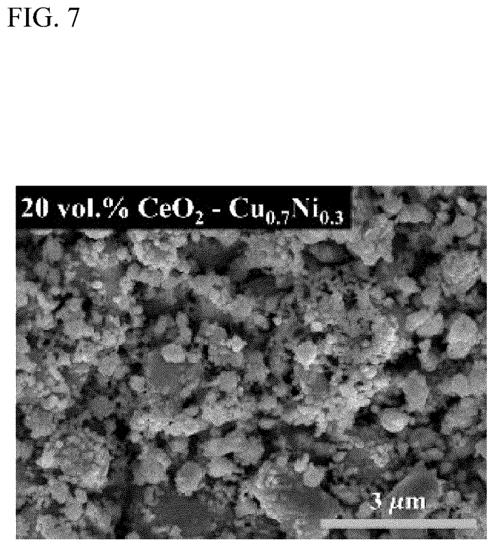

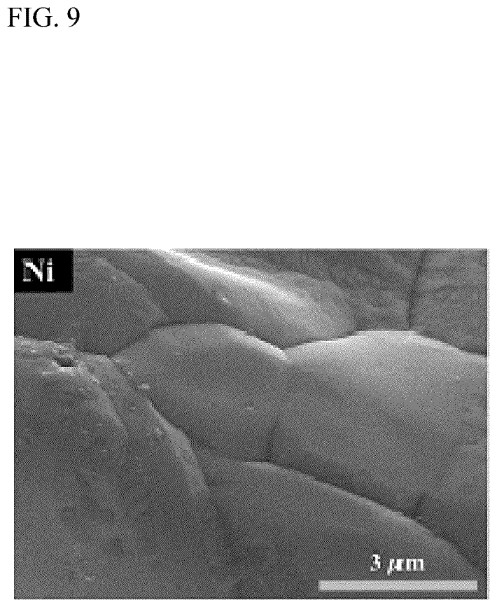

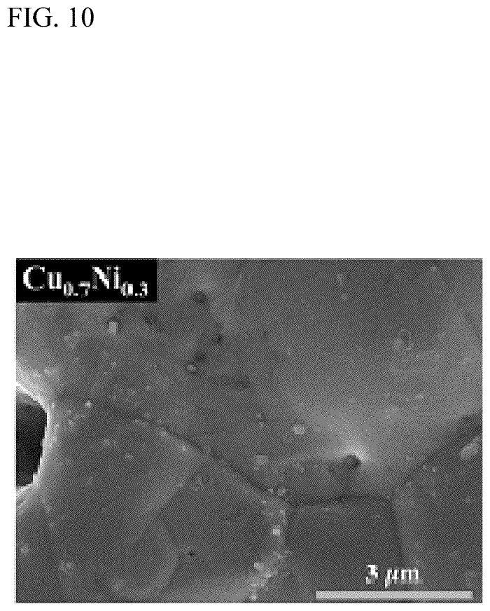

The electrode current collectors manufactured in the manufacture examples were analyzed with a scanning electron microscope (SEM), and the photographs thereof were illustrated in FIGS. 5 to 10. FIGS. 5 to 10 illustrate Manufacture Examples 1 to 3 and Comparative Manufacture Examples 1 to 3 in order, respectively.

As illustrated in FIGS. 5 to 7, in the electrode current collectors manufactured in Manufacture Examples 1 to 3, it was confirmed that the pores were appropriately formed.

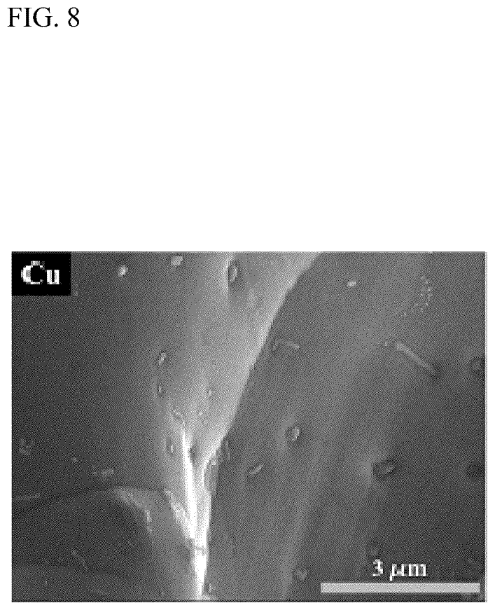

On the other hand, as illustrated in FIGS. 8 to 10, in the electrode current collectors manufactured in Comparative Manufacture Examples 1 to 3, it was confirmed that pores were not formed well and sintered into a dense structure.

### Experimental Example 3: Conversion Comparison

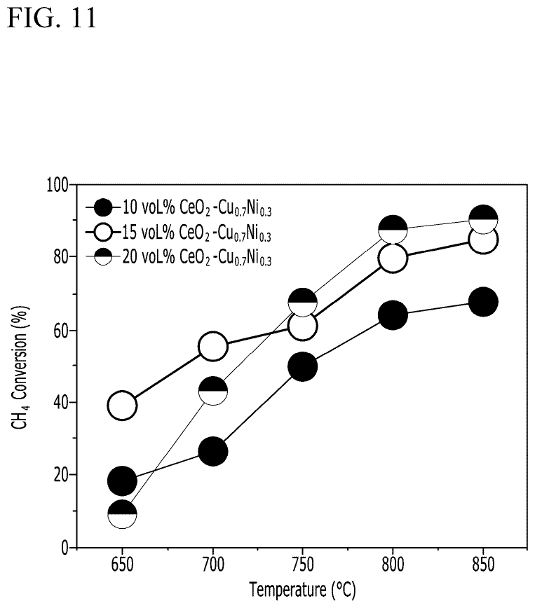

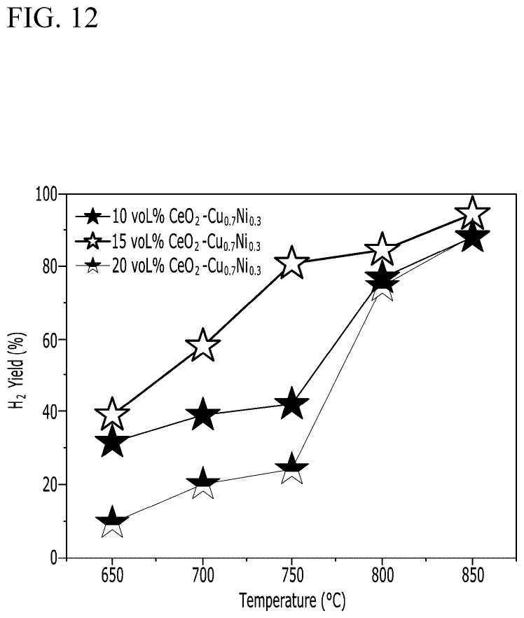

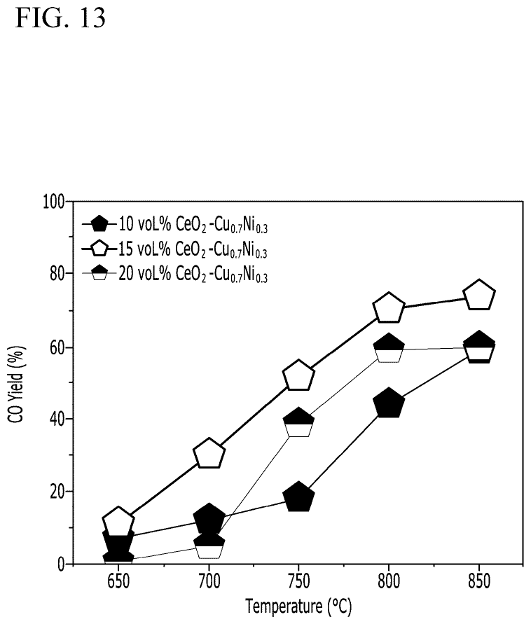

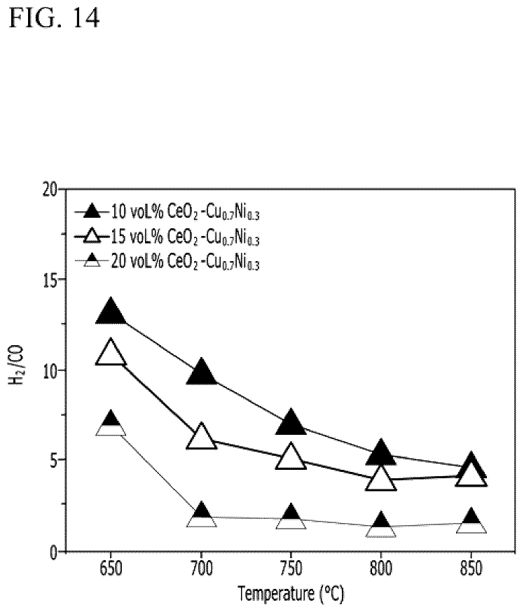

The conversion of CH₄, the yields of H₂ and CO, and the H₂/CO ratio were measured using gas chromatography, and the results thereof were illustrated in FIGS. 11 to 14, respectively.

In order to determine the catalytic performance, quantitative and qualitative analysis was performed using gas chromatography. In the measurement, a sample was placed on the same alumina holder as for the SOFC measurement and attached using a glass sealing paste obtained by mixing glass powder with a binder, and quartz tubes were used to prepare two chambers for in and out. This is similar to the SOFC sealing method. Moisture was collected from gas reformed by passing methane-steam mixed gas through a catalyst using a cooler, and the gas was flowed through gas chromatography to detect CH₄, CO, CO₂, H₂, and the like. The conversion of CH₄, the yields of H₂ and CO, and the H₂/CO ratio were measured through quantitative and qualitative analysis using gas chromatography, and the results thereof were illustrated in FIGS. 11 to 14, respectively.

It was confirmed that the methane conversion was the highest at about 39% in Manufacture Example 1 (10 vol. % CeO₂—Cu_{0.7}Ni_{0.3}) at an intermediate temperature of 650° C., and the methane conversion was the highest at 82% in Manufacture Example 2 (15 vol. % CeO₂—Cu_{0.7}Ni_{0.3}) at a high temperature of 850° C.

It was confirmed that the hydrogen yield was the highest at about 39% in Manufacture Example 1 (10 vol. % CeO₂—Cu_{0.7}Ni_{0.3}) at 650° C., and the hydrogen yield was the highest at 94% in Manufacture Example 1 (10 vol. % CeO₂—Cu_{0.7}Ni_{0.3}) at 850° C.

It was confirmed that the carbon monoxide yield was the highest at about 11% in Manufacture Example 1 (10 vol. % CeO₂—Cu_{0.7}Ni_{0.3}) at 650° C., and the carbon monoxide yield was the highest at 74% in Manufacture Example 1 (10 vol. % CeO₂—Cu_{0.7}Ni_{0.3}) at 850° C.

As such, it can be confirmed that an electrode current collector having the optimal hydrocarbon reforming performance may be manufactured in individual operating environments by adjusting the mixing ratio of the metal and oxide that constitute the current collector.

### Experimental Example 4: Measurement of Electrical Conductivity by Temperature

In order for a current collector having a catalytic function to replace the existing Ni-based current collector (Comparative Manufacture Example 2: Ni foam), a sufficient electrical conductivity needs to be secured to maintain current collection efficiency.

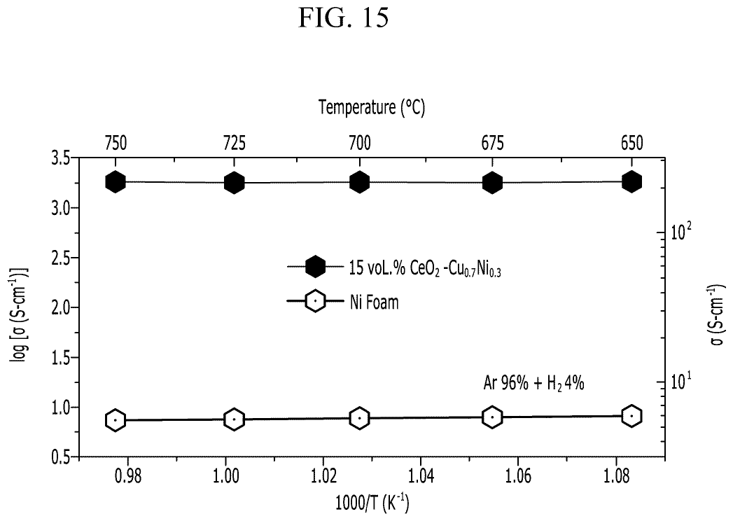

The electrical conductivity of the electrode current collector manufactured in Manufacture Example 1 (10 vol. % CeO₂—Cu_{0.7}Ni_{0.3}) was measured in a reducing atmosphere at 650° C. to 750° C., which is the actual current collector utilization condition, and the result was illustrated in FIG. 15. As illustrated in FIG. 15, it was confirmed that the electrode current collector manufactured in Manufacture Example 1 (10 vol. % CeO₂—Cu_{0.7}Ni_{0.3}) had a relatively excellent electrical conductivity (about 1.832×10³ S/cm at 750° C.), which was sufficient to be used as a current collector.

### Experimental Example 5: SEM-EDS Analysis

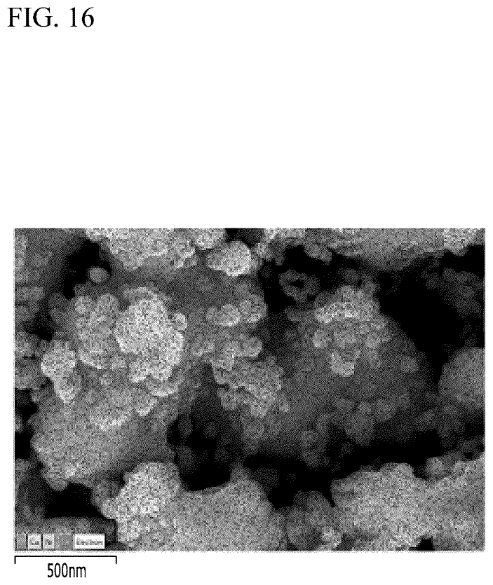

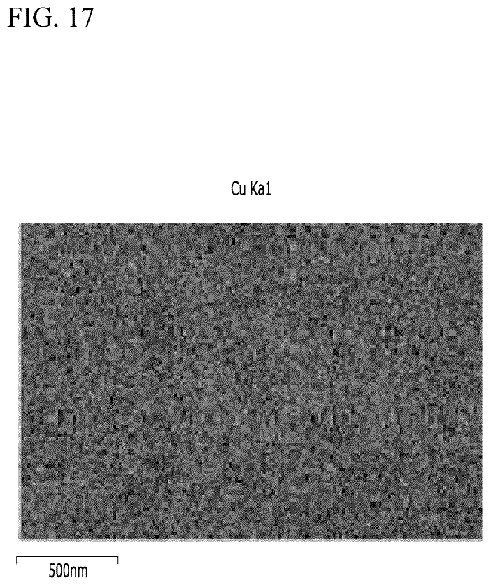

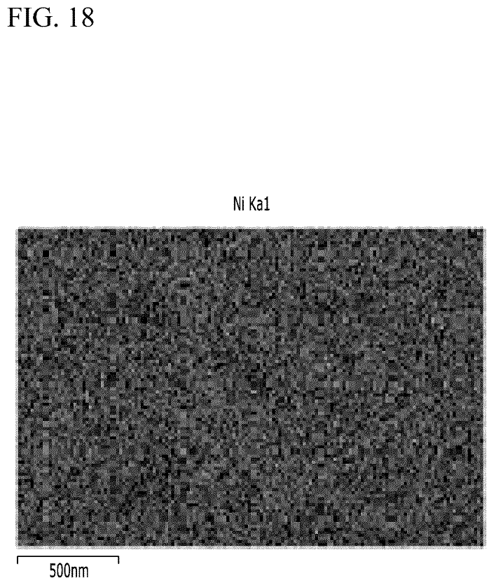

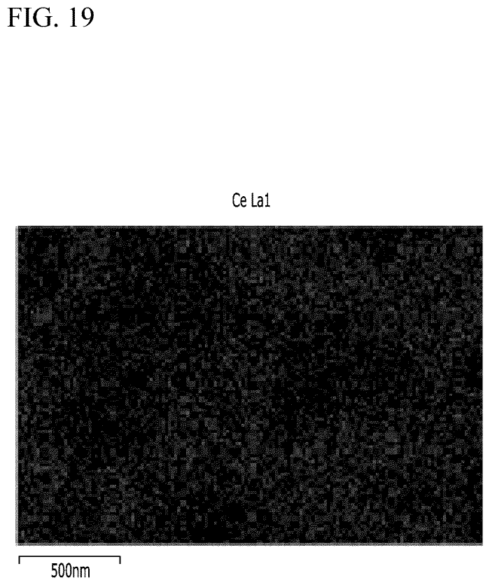

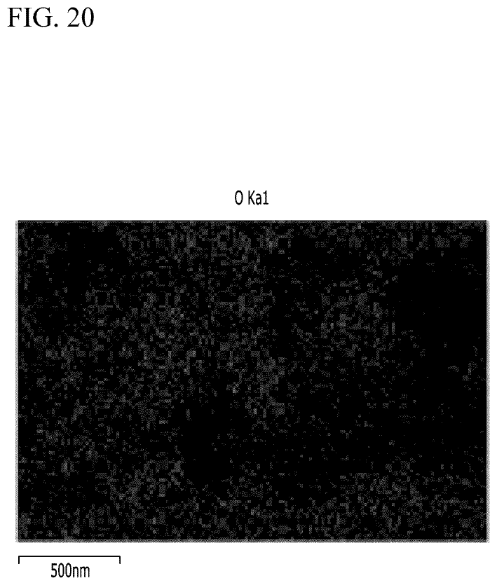

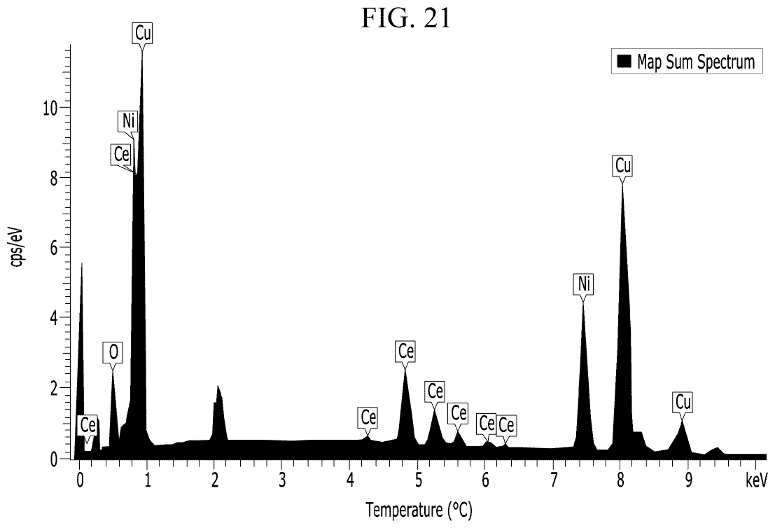

The components of the electrode current collector of Manufacture Example 2 (15 vol % CeO₂—Cu_{0.7}Ni_{0.3}) and contents thereof were measured using an energy dispersive X-ray spectroscope (EDS) equipped in the SEM equipment, and the results thereof were illustrated in FIGS. 16 to 21.

It was confirmed that a total of 15.01 wt % of Ni, 58.08 wt % of Cu, 12.44 wt % of Ce, and 4.47 wt % of O were contained.

### Experimental Example 6: Comparison with Fe and Ni Alloys

An electrode current collector was manufactured in the same manner as that of Manufacture Example 1, except that iron (III) nitrate nonahydrate (Fe(NO₃)₃·9H₂O) was used instead of copper (II) nitrate trihydrate (Cu(NO₃)₂·3H₂O). This was named Comparative Manufacture Example 4 (10 vol % CeO₂—Ni_{0.7}Fe_{0.3}).

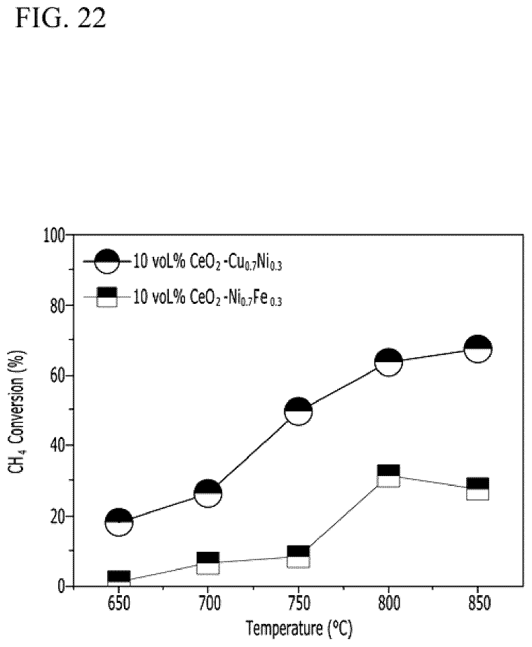

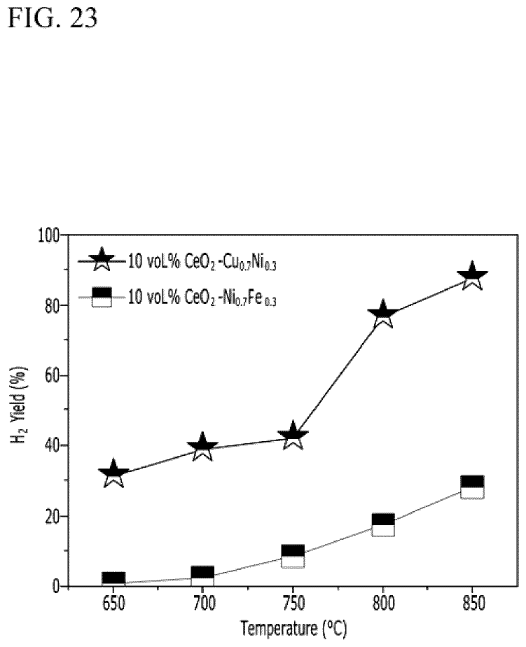

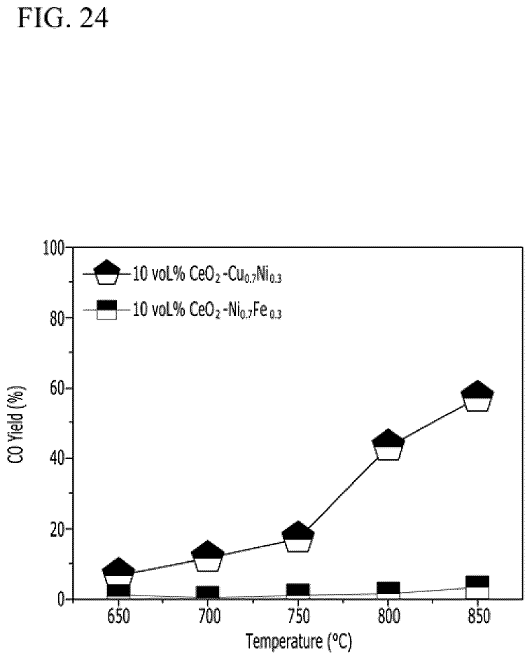

The methane conversion and the hydrogen and carbon monoxide yields were measured in the same manner as that of Experimental Example 4, and the results thereof were illustrated in FIGS. 22 to 24.

As illustrated in FIGS. 22 to 24, it was confirmed that the conversion and yields of Manufacture Example 1 were significantly superior to those of Comparative Manufacture Example 4.

Although the preferred exemplary embodiments of the present disclosure have been described above, the present disclosure is not limited thereto, and various modifications may be made without departing from the range of the claims, detailed description, and accompanying drawings, which belong to the scope of the present disclosure.

Accordingly, the substantive scope of right of the present disclosure will be defined by the appended claims and equivalents thereof.

### DESCRIPTION OF SYMBOLS

10: Anode current collector,
20: Anode bipolar plate,
30: Cell,
31: Anode,
32: Anode functional layer,
33: Electrolyte,
34: Cathode,
40: Cathode current collector,
50: Cathode bipolar plate,
51: Bipolar plate coating layer
100: Solid oxide fuel cell,

What is claimed is:

1. An electrode current collector comprising:
an alloy containing Ni and Cu, and CeO2,
a porosity of the electrode current collector is 25 to 80%.

2. The electrode current collector of claim 1, wherein:
the alloy containing Ni and Cu contains 20 to 50 parts by weight of Ni and 50 to 80 parts by weight of Cu, with respect to 100 parts by weight of the alloy.

3. The electrode current collector of claim 1, wherein:
CeO2 is included in an amount of 5 to 25 parts by volume with respect to 100 parts by volume of the alloy containing Ni and Cu.

4. A method of manufacturing an electrode current collector, the method comprising:
preparing a mixed powder by mixing an alloy powder containing Ni and Cu with CeO2;
manufacturing a molded body by applying a pressure to the mixed powder; and
subjecting the molded body to a heat treatment at 450 to 1,000° C.

5. The method of claim 4, wherein:
the alloy powder contains 20 to 50 parts by weight of Ni and 50 to 80 parts by weight of Cu, with respect to 100 parts by weight of the alloy powder.

6. The method of claim 4, wherein:
the mixed powder includes 100 parts by volume of the alloy powder and 5 to 25 parts by volume of CeO2.

7. A solid oxide fuel cell comprising the electrode current collector of claim 1.
